(19) United States
(12) Patent Application Publication
(10) Pub. No.: US 2026/0309225 A1
(43) Pub. Date: Oct. 8, 2026

(54) VEHICLE COMPRISING A TRANSMISSION

(71) Applicant: AUDI AG, Ingolstadt (DE)

(72) Inventors: Enrico SZEPPAT, Lunzenau (DE); Lutz GUNDLACH, Ingolstadt (DE)

(21) Appl. No.: 19/482,179

(22) PCT Filed: May 7, 2024
(86) PCT No.: PCT/EP2024/062505

§ 371 Date: Nov. 6, 2025

(30) Foreign Application Priority Data
May 11, 2023 (DE) 10 2023 112 390.4

(51) Int. Cl. F16H 61/16; F16H 61/04

(52) U.S. Cl. CPC F16H 61/16; F16H 61/0437; F16H 2061/161; F16H 2061/163

(57) ABSTRACT

A vehicle is disclosed, and may include transmission including an electronic control unit configured to control engaging and disengaging gears of the transmission, and a target gear configured to be engaged by way of the control unit when the vehicle is at a standstill. The control unit may be configured to begin a shifting routine in which an intermediate gear is engaged when a tooth-on-tooth position of the target gear shifting partners is detected. The control unit may include a checking device configured to check which gear is suitable as an intermediate gear before the intermediate gear is engaged so as to generate a compensating rotational movement in the transmission during the engagement.

### BACKGROUND

### Technical Field

The present disclosure relates to a vehicle comprising a transmission with an electronic control unit.

### Description of the Related Art

A vehicle comprises a transmission, in particular a dual clutch transmission, including an electronic control unit for engaging and disengaging gears. The control unit can be used to engage or preselect a target gear while the vehicle is at a standstill. The target gear can be a starting gear, for example, by way of which the vehicle is started after the vehicle standstill is ended. Alternatively, the target gear can be part of a parking lock function. To activate such a parking lock function, the two separating clutches of the dual clutch transmission are first released. A preselected gear is then engaged. As soon as the control unit detects that the vehicle is at a standstill, a locking gear is additionally engaged to block the transmission.

If the control unit detects a tooth-on-tooth position of the target gear shifting partners, the control unit starts a shifting routine beginning with the engagement of the target gear being interrupted. In addition, the control unit engages an intermediate gear, different from the target gear, so as to generate a compensating rotational movement in the transmission with the engagement of the intermediate gear. The goal is to solve the tooth-on-tooth position by way of the compensating rotational movement. The control unit then engages the target gear, now without interfering contours, while the intermediate gear is disengaged again.

So as to generate a compensating rotational movement, it is necessary for the shifting partners of the intermediate gear to be at least slightly rotationally offset in relation to each other. On the other hand, no compensating rotational movement is generated if the shifting partners are perfectly oriented in axial alignment. Therefore, if the control unit selects an intermediate gear whose shifting partners are perfectly aligned with each other, no compensating rotational movement is generated. In this case, therefore, the tooth-on-tooth position of the shifting partners of the target gear cannot be solved.

A vehicle of the type in question comprising a transmission is known from U.S. Pat. No. 9,816,608. A force-fit substitute gear strategy in a transmission is known from DE102014225453A1, in which a tooth-on-tooth position of an involved form-locked claw coupling is solved. A shifting strategy in which a tooth-on-tooth position is solved by shaft rotation using the coupling drag torque is known from DE102015213683A1.

### BRIEF SUMMARY

The present disclosure provides a vehicle comprising a transmission, by way of which gear shifts when at a standstill can be carried out in a simple and operationally reliable manner compared to the state of the art.

The present disclosure is directed to a vehicle comprising a transmission including an electronic control unit by way of which transmission gears can be engaged and disengaged. The electronic control unit can be used to engage a target gear while a vehicle is at a standstill. For example, the target gear can be a starting gear by way of which the vehicle is started after the vehicle standstill has ended. Alternatively, the target gear can be part of a parking lock function. To activate such a parking lock function, the two separating clutches of the dual clutch transmission are first released. A preselected gear is then engaged. As soon as the control unit detects that the vehicle is at a standstill, a locking gear is additionally engaged to block the transmission.

If the control unit detects a tooth-on-tooth position of the target gear shifting partners when the target gear is being engaged, the control unit starts a shifting routine beginning with the engagement of the target gear being interrupted. The control unit additionally engages an intermediate gear different from the target gear. Engaging the intermediate gear is intended to generate a compensating rotational movement in the transmission, by way of which the tooth-on-tooth position is solved. The control unit can then engage the target gear, now without interfering contours, and, in particular, can also disengage the intermediate gear again. The control unit is assigned a checking device which carries out an intermediate gear check. The intermediate gear check is used to check in advance which gear is suitable as an intermediate gear in order to generate the compensating rotational movement in the transmission during engagement. The intermediate gear considered to be suitable by the checking device is then engaged by the transmission control unit.

The checking device detects all the gears that were engaged while the vehicle was at a standstill up until the time of the check during the intermediate gear check. The checking device considers a gear that was already engaged while the vehicle was at a standstill to be an unsuitable intermediate gear. Conversely, the checking device considers a gear that was not yet engaged while the vehicle was at a standstill to be a suitable intermediate gear.

The intermediate gear check described above is based on the fact that a gear that is engaged while the vehicle is at a standstill can no longer successfully act as an intermediate gear. In this case, the shifting partners of this gear are aligned tooth-on-gap (due to the gear engagement having already taken place). Re-engaging this gear (as an intermediate gear) can therefore not lead to a desired compensating rotational movement in the transmission.

It is preferable if the intermediate gear check of the checking device can be carried out utilizing sensors that are already installed in the transmission. Against this background, position or path sensors which detect a position or a travel distance of gear shift elements while the vehicle is at a standstill are suitable. When a change in position or travel distance of a gear shift element is detected, the associated shifted gear can therefore be considered by the checking device to be an unsuitable intermediate gear.

In some embodiments, the transmission, in particular a sub-transmission of a dual clutch transmission, has a number of gear wheel levels, each of which forms gears. Each gear wheel level comprises a shift gear wheel loosely rotatably mounted on a transmission shaft and a fixed gear wheel meshing therewith and arranged on another transmission shaft. The shift gear wheel can be coupled to the associated transmission shaft by way of a gear shift element. The gear shift element can be a sliding sleeve, which sits with the inner gearing thereof on a corresponding outer gearing of a sliding sleeve carrier, which is non-rotatably arranged on the transmission shaft. To engage a gear, the sliding sleeve can be adjusted axially, proceeding from a neutral position to a shift position. In the shift position, the sliding sleeve inner gearing can be in meshing engagement with the sliding sleeve carrier on the one hand and with the outer gearing of a clutch body of the shift gear wheel to be engaged on the other hand. In the tooth-on-tooth position, the teeth of the sliding sleeve inner gearing strike to full contact against the teeth of the outer gearing of the clutch body of the shift gear wheel to be engaged. In contrast, a tooth-on-gap position allows the sliding sleeve to move smoothly through to the shift position thereof.

In the dual clutch transmission, a first drive shaft and a second drive shaft can be connectible to a drive unit, such as an internal combustion engine, by way of clutches of a dual clutch. A first sub-transmission can be activated by way of the first drive shaft, while a second sub-transmission can be activated by way of the second drive shaft. In the case of such a dual clutch transmission, it is necessary for the checking device to select a suitable intermediate gear that is arranged together with the target gear in the same sub-transmission. This provides a rotary connection from the intermediate gear to the target gear, via which the compensating rotational movement can be transferred from the intermediate gear to the target gear.

### BRIEF DESCRIPTION OF THE SEVERAL VIEWS OF THE DRAWINGS

FIG. 1 shows a schematic view of a dual clutch transmission according to the present disclosure.

FIG. 2 shows a detailed view of a first gear shift element of the dual clutch transmission of FIG. 1 in engagement with a gear.

FIG. 3 shows a detailed view of the first gear shift element of FIG. 2 experiencing tooth on tooth contact with a gear.

FIG. 4 shows schematic view of the dual clutch transmission of FIG. 1 during an intermediate gear check.

FIG. 5 shows a detailed view of a second gear shift element of the dual clutch transmission of FIG. 1 during an intermediate gear check.

### DETAILED DESCRIPTION

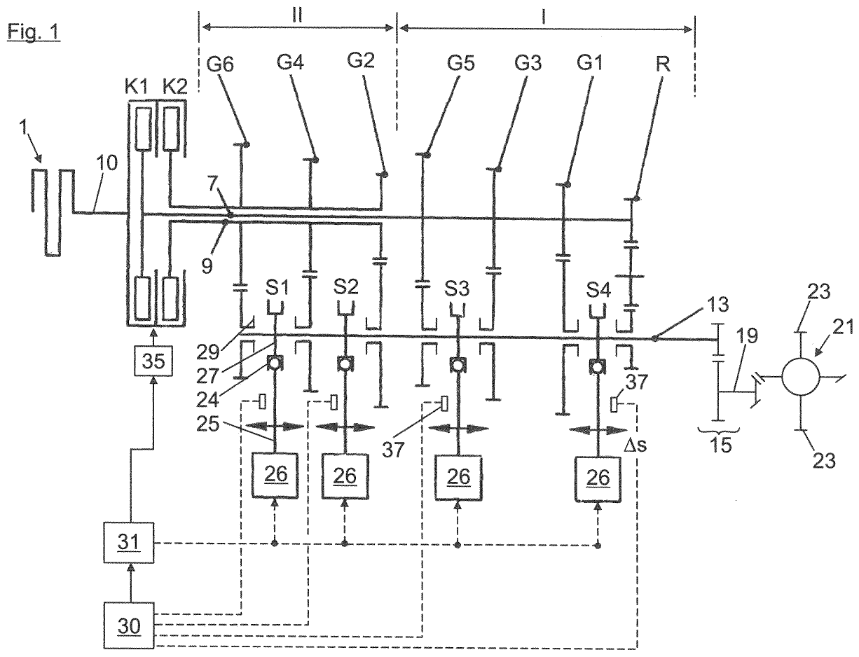

FIG. 1 shows a transmission structure of a drive train of a motor vehicle, which comprises an internal combustion engine 1 and a dual clutch transmission. The dual clutch transmission comprises a first drive shaft 7 and a second drive shaft 9. The first and second drive shafts 7, 9 are arranged coaxially and can alternately be connected in a torque-transmitting manner to a power output shaft 10 of the internal combustion engine 1 by way of two, for example hydraulically actuatable, power-shiftable separating clutches K1, K2. In FIG. 1, the first drive shaft 7 is implemented as a solid shaft, which is guided coaxially within the second drive shaft 9 implemented as a hollow shaft. An output shaft 13 is provided axially parallel to the first and second drive shafts 7, 9. The output shaft 13 drives an input shaft 19 of an axle differential 21 via a gear wheel step 15 having spur gears. Flange shafts 23 lead from the axle differential 21 on both sides to vehicle wheels, which are not shown.

The first and second drive shafts 7, 9 can each be used to activate a first sub-transmission I and a second sub-transmission II of the dual clutch transmission. In the figure, the first sub-transmission I is axially spaced apart from the dual clutch K1, K2 by way of the interposed second sub-transmission II. Fixed and idler gear wheels are arranged in wheel planes on the two drive shafts 7, 9 and on the output shaft 13. The fixed and idler gear wheels are combined into gear wheel sets forming six forward gear steps G1, G2, G3, G4, G5, G6 and one reverse gear step R. In FIG. 1, the idler gear wheels of all gear steps are positioned on the output side on the output shaft 13. The idler gear wheels can be shifted with the aid of gear shift elements S1, S2, S3, S4, which are likewise positioned on the output shaft 13.

Each of the gear shift elements S1, S2, S3, S4 is implemented as a synchronous clutch having a sliding sleeve 24, which can be adjusted axially on one side or both sides over a travel distance by way of an indicated shifting fork 25. The sliding sleeve 24 sits with the inner gearing thereof, which is not shown, on corresponding outer gearing of a sliding sleeve carrier 27 that is non-rotatably arranged on the output shaft 13. Each of the sliding sleeves 24 is positioned in a neutral position in FIG. 1. Proceeding from the neutral position, the sliding sleeves 24 can be moved to a shift position in order to shift a gear. In the shift position, the sliding sleeve inner gearing is in meshing engagement with the sliding sleeve carrier 27 on the one hand and with the outer gearing of a clutch body 29 of a shift gear wheel on the other hand. In FIG. 2, the sliding sleeve 24 of the gear shift element S4 is located, by way of example, in the left shift position thereof, in which the first gear G1 is shifted.

In FIG. 1, each of the shifting forks 25 is operatively connected to an actuator 26, for example, a hydraulically operating actuator, which can be controlled by a shift control unit 31. When controlled accordingly, the shifting fork 25 is moved axially over a travel distance As so as to bring the associated sliding sleeve 24 into or out of coupling engagement with a shift gear wheel.

The travel distances As of the shifting forks 25 are detected by path sensors 37, which, amongst others, are in signal connection with a checking device 30, which is assigned to an electronic transmission control unit 31. The electronic transmission control unit 31 can be used to control the actuators 26 and a clutch control unit 35 of the dual clutch K1, K2.

While the vehicle is at a standstill, the internal combustion engine 1 is switched off while the separating clutches K1, K2 are disengaged. Accordingly, the drive shafts 7, 9 and the output shaft 13 are likewise at a standstill. In this case, the transmission control unit 31 can preselect the first gear G1 as the starting gear, in preparation for a new driving operation, as is shown in FIG. 2. Accordingly, when the first gear G1 is engaged, the sliding sleeve 24 of the gear shift element S4 is displaced into the left shift position thereof.

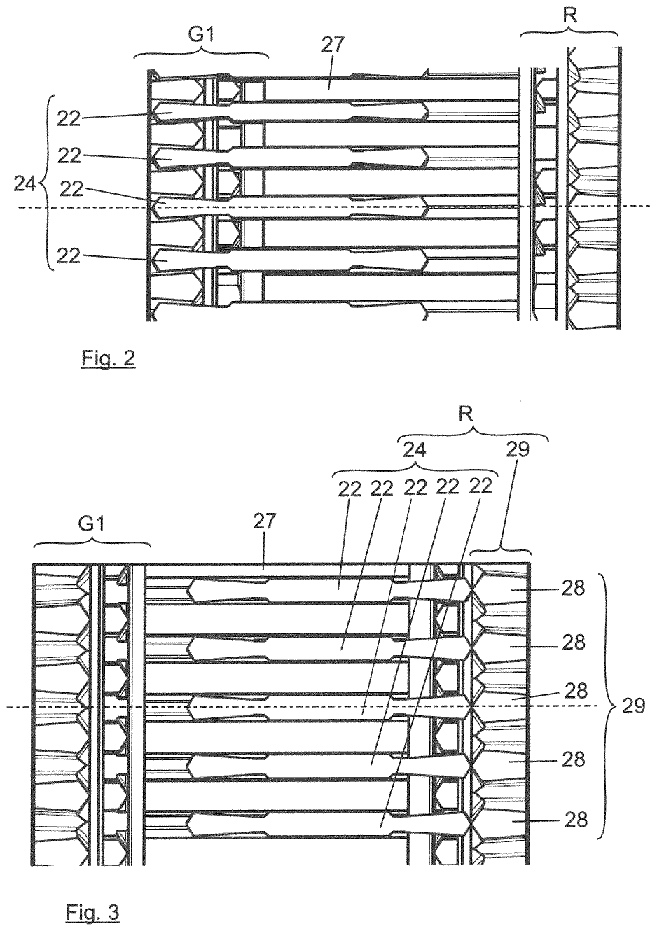

The present disclosure relates to a gear change while the vehicle is at a standstill, and more particularly, by way of example, from the previously preselected first gear G1 to the reverse gear R (as the new target gear). Such a gear change can result, for example, due to a change in the gear selection by the user while the vehicle is at a standstill. However, the gear change from the first gear G1 to the reverse gear R (that is, target gear) may be blocked due to a tooth-on-tooth position, as is shown in FIG. 3. Accordingly, the teeth 22 of the inner gearing of the sliding sleeve 24 strike to full contact against the teeth 28 of the outer gearing of the clutch body 29 of the shift gear wheel of the reverse gear R.

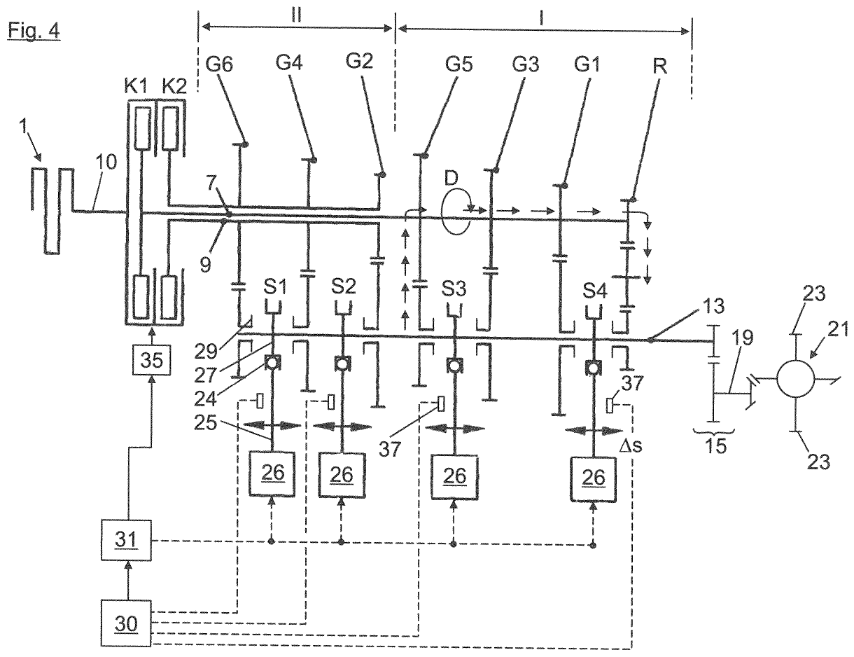

When the tooth-on-tooth position of the reverse gear shifting partners (that is, sliding sleeve 24 and clutch body 29) is recognized, the transmission control unit 31 starts a routine beginning with the engagement of the reverse gear R being interrupted. In addition, the checking device 30 carries out an intermediate gear check in which a suitable intermediate gear is selected, during the engagement of which a compensating rotational movement D, as shown in FIG. 4, is generated in the transmission, by way of which the tooth-to-tooth position of the reverse gear shifting partners 24, 29 can be solved.

The intermediate gear considered to be suitable by the checking device 30 is engaged by the transmission control unit 31. In the present exemplary embodiment, the transmission control unit 31 selects the fifth gear G5 as a suitable intermediate gear. After briefly engaging and disengaging the fifth gear G5 forming the intermediate gear, the transmission control unit 31 actuates the shifting fork 25 of the gear shift element S4 so as to engage the reverse gear R (as the target gear), now without interfering contours.

The intermediate gear check according to the disclosure carried out by the checking device 30 is described below. Accordingly, all gears G1, G2, G3, G4, G5, G6 that were already engaged while the vehicle was at a standstill up until the intermediate gear check are detected by the checking device 30 during the intermediate gear check. The checking device 30 categorizes the gears G1, G2, G3, G4, G5, G6. A gear that was already engaged while the vehicle was at a standstill is considered to be an unsuitable intermediate gear. Conversely, a gear that was not yet engaged while the vehicle was at a standstill is considered to be a suitable intermediate gear. In the present exemplary embodiment, the first gear G1 was already engaged as a preselected gear while the vehicle was at a standstill. This was followed by the gear change to the reverse gear R (as the target gear). The checking device 30 therefore considers the first gear G1 to be an unsuitable intermediate gear, while the gear G5 (or alternatively also the gear G3) is considered to be a suitable intermediate gear.

This intermediate gear check carried out by the checking device 30 is based on the fact that a gear that was already engaged while the vehicle was at a standstill (in the present case, the first gear G1) can no longer successfully effectuate a compensating rotational movement D as an intermediate gear. This is because the shifting partners (sliding sleeve 24 and gear wheel clutch body 29) of this gear G1, which was already engaged while the vehicle was at a standstill, are already aligned in a tooth-on-gap position due to the previously implemented engagement. Re-engaging this gear G1 would therefore not lead to a compensating rotational movement D in the transmission.

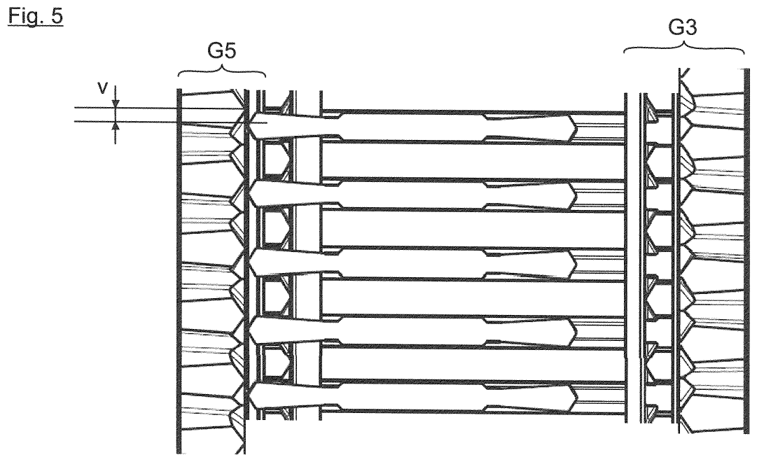

In contrast, there is a high probability that in the fifth gear G5, which is considered to be suitable, the shifting partners 24, 29 are slightly rotated by a rotational offset v as shown in FIG. 5. A compensating rotational movement D is therefore generated when the fifth gear G5 is being engaged, as shown in FIG. 4, by way of which the tooth-on-tooth position of the shifting partners 24, 29 of the reverse gear R can be solved.

It is relevant that the intermediate gear G5 considered to be suitable by the checking device 30 and the reverse gear R are arranged in the same sub-transmission I. This ensures a rotary connection (indicated by arrows in FIG. 4) from the intermediate gear G5 via the drive shaft 7 to the target gear (that is, reverse gear R), so that the compensating rotational movement D, as shown in FIG. 4, is transmitted from the intermediate gear G5 to the target gear (that is, reverse gear R) in a movement path.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A vehicle comprising:
a transmission including:
an electronic control unit configured to control engaging and disengaging gears of the transmission, the electronic control unit including a checking device; and
a target gear configured to be engaged by way of the control unit while the vehicle is at a standstill,
wherein the control unit is configured to begin a shifting routine when a tooth-on-tooth position of target gear shifting partners is detected during a gear change from a preselected gear to the target gear while the vehicle is at a standstill, the preselected gear being a gear that was previously engaged,
wherein in the shifting routine, the control unit is configured to:
interrupt the engagement of the target gear;
engage an intermediate gear different from the target gear, such that a compensating rotational movement is effectuated in the transmission with the engagement of the intermediate gear to move the target gear shifting partners from the tooth-on-tooth position; and
re-engage the target gear without interfering contours and disengage the intermediate gear,
wherein the checking device is configured to carry out an intermediate gear check in advance of the shifting routine, the intermediate gear check including checking which of the gears is suitable to be the as an intermediate gear to generate the compensating rotational movement in the transmission during the engagement of the intermediate gear,
wherein the intermediate gear engaged by the control unit is considered to be suitable by the checking device, and
wherein the checking device is further configured:
to detect, during the intermediate gear check, all gears that were engaged while the vehicle was at a standstill prior to the intermediate gear check;
to consider a gear that was engaged while the vehicle was at a standstill to be an unsuitable intermediate gear; and
to consider a gear that was not yet engaged while the vehicle was at a standstill to be a suitable intermediate gear.

2-4. (canceled)

5. The vehicle according to claim 1, wherein the intermediate gear check of the checking device is carried out utilizing position or path sensors configured to detect a position or a travel distance of gear shift elements while the vehicle is at a standstill.

6. The vehicle according to claim 5, wherein the control unit is configured such that, when a change in position or travel distance of a gear shift element is detected, an associated gear of the gear shift element is considered to be an unsuitable intermediate gear by the checking device.

7. The vehicle according to claim 1, wherein the transmission is sub-transmission of a dual clutch transmission, wherein the transmission has a plurality of gear-forming gear wheel levels.

8. The vehicle according to claim 7, wherein the transmission is configured as a dual clutch transmission, the dual clutch transmission comprising a first drive shaft and a second drive shaft,
wherein the first drive shaft and the second drive shaft are each configured to be connected to a drive unit via respective clutches of a dual clutch, and
wherein a first sub-transmission and a second sub-transmission are configured to be activated by way of a respective one of the first and second drive shafts.

9. The vehicle according to claim 8, wherein the checking device is configured to select a suitable intermediate gear arranged with the target gear on one sub-transmission.

10. (canceled)

11. The vehicle according to claim 7, wherein each gear-forming gear wheel level includes:
a shift gear wheel is loosely rotatably mounted on a first transmission shaft; and
a fixed gear wheel configured to mesh with a respective shift gear wheel and arranged on a second transmission shaft,
wherein the shift gear wheel is configured to be coupled to the transmission shaft by way of a gear shift element, the gear shift element comprising a sliding sleeve configured to rest on a corresponding outer gearing of a sliding sleeve carrier that is non-rotatably arranged on the transmission shaft, the sliding sleeve configured to rest on the corresponding outer gearing of the sliding sleeve carrier by way of inner gearing of the sliding sleeve,
wherein, for gear engagement, the sliding sleeve is configured to be moved from a neutral position into a shift position,
wherein, in the shift position, the inner gearing of the sliding sleeve is in meshing engagement with the sliding sleeve carrier and with outer gearing of a clutch body of the shift gear wheel to be engaged on the other hand, and
wherein, in the tooth-on-tooth position, the teeth of the inner gearing of the sliding sleeve strike against teeth of the outer gearing of the clutch body of the shift gear wheel to be engaged.
